(19) United States
(12) Patent Application Publication
(10) Pub. No.: US 2009/0187685 A1
(43) Pub. Date: Jul. 23, 2009

(54) INFORMATION RECORDING APPARATUS

(76) Inventors: Morio Aoki, Yokohama (JP); Shingo Ito, Yokohama (JP)

Correspondence Address: MCDERMOTT WILL & EMERY LLP, 600 13TH STREET, N.W., WASHINGTON, DC, 20005-3096, US

(21) Appl. No.: 12/352,210

(22) Filed: Jan. 12, 2009

(30) Foreign Application Priority Data
Jan. 18, 2008 (JP) 2008-009607

(51) Int. Cl. G06F 13/38; G06F 13/00

(52) U.S. Cl. 710/71; 710/110

(57) ABSTRACT

An information recording apparatus is disclosed, in which a HDD is connected to an ATA bus as a master device, an optical disk drive is connected as a slave device to a connector by an eSATA interface, and a system control unit asserts a PDAIG signal at the time of activating the information recording apparatus.

### INCORPORATION BY REFERENCE

The present application claims priority from Japanese application JP2008-009607 filed on Jan. 18, 2008, the content of which is hereby incorporated by reference into this application.

### BACKGROUND OF THE INVENTION

This invention relates to an information recording apparatus with a storage device connected to a host controller by an ATA interface, or in particular to a video camera.

A hybrid video camera having a hard disk drive and an optical disk drive built therein is available. In this video camera, the hard disk drive and the optical disk drive are connected to the host controller through the ATA interface.

In this video camera, the hard disk drive operates as a master device while the optical disk drive such as the DVD drive or the blu-ray disk drive operates as a slave device, thereby making possible the dubbing of the audio/video signal recorded in the hard disk drive to the optical disk drive.

Incidentally, the conventional technique of the process for controlling the status of the storage device drive connected to the host controller by the ATA interface is disclosed, for example, in JP-A-2000-267983 and JP-A-2004-178052.

### SUMMARY OF THE INVENTION

A method may be conceived to reduce the size and weight of the information recording apparatus having plural built-in recording means adapted for recording in plural recording media, in which a given one of the recording means is not built in the information recording apparatus but replaceable and connected as required.

A method available to connect and control the internal parts of the information recording apparatus requires the process in which one recording means detects the standby state of the recording means at the time of activation, after which the one recording means outputs to the control unit the notification that the standby state of all the recording means including itself is complete. In the ATA specification, for example, the master device detects the standby state of the slave device.

The control method described above, however, poses the problem that the information recording apparatus cannot be normally activated from the state in which the replaceable recording means is not connected to the information recording apparatus.

The object of this invention is to solve this problem and provide an information recording apparatus which can be activated normally even in the case where the replaceable recording means is not connected.

In order to achieve the object described above, according to this invention, there is provided an information recording apparatus activated in such a manner that the control unit of the information recording apparatus outputs an ATA signal related to the status of a slave device to a built-in master device, so that the information recording apparatus can be normally activated without outputting the ATA signal to the master device from the slave device.

According to this invention, an information recording apparatus is provided which can be normally activated even in the case where a replaceable one of the recording means is not connected to the information recording apparatus.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a video camera according to a first embodiment of the invention.

FIG. 2 is a flowchart for explaining the operation performed according to the activation process program by the system control unit of the video camera.

FIG. 3 is a flowchart for explaining the operation performed according to the dubbing process program by the system control unit of the video camera.

FIG. 4 is a block diagram showing a video camera according to a second embodiment of the invention.

### DETAILED DESCRIPTION OF THE INVENTION

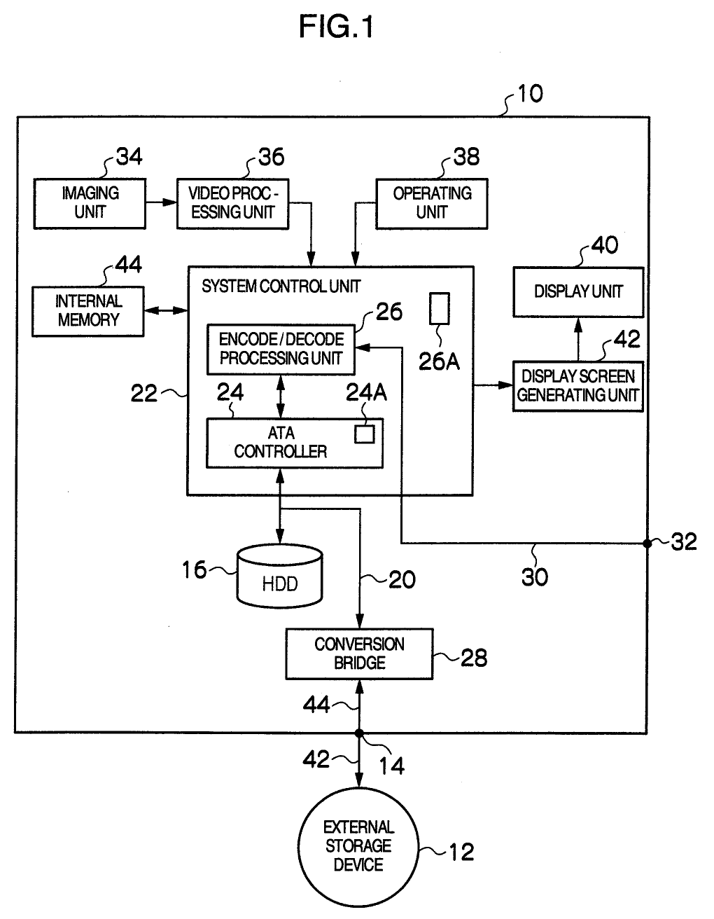

Now, an embodiment of the invention is explained. FIG. 1 shows a block configuration of a video camera 10 constituting an information recording apparatus. Reference numeral 12 designates an external storage device connected to the video camera 10 as a slave device including a CD drive, a DVD drive, a blu-ray disk drive, a HDDVD drive or the like optical disk drive or a hard disk drive. Numeral 14 designates a connector of the storage device.

The video camera 10 includes a system control unit 22 for executing the control operation to record or reproduce an audio/video signal, a parallel ATA bus 20 and a hard disk drive (HDD) 16. The HDD 16 constituting a master device is connected to the parallel ATA bus 20. The parallel ATA bus may be hereinafter referred to as an ATA bus, the HDD 16 as a master device and the external storage device 12 as a slave device.

The video camera 10 includes a conversion bridge 28 for converting the parallel ATA and the serial ATA to each other. The conversion bridge 28 is connected to the ATA bus 20 on the one hand and to the connector 14 through the serial ATA bus 44 on the other hand. The ATA interface used for the video camera 10 is configured in accordance with, for example, ATA-5 meeting the ATAPI standard as well as the IDE standard to permit the connection of the optical disk drive 12 as an external unit.

The ATA bus 20 is connected to an ATA controller (host controller) 264 of the system control unit 22. An encode/decode processing unit 26 of the system control unit 22 is connected to the ATA controller. The conversion bridge 28 is connected to an external device connector and the serial ATA interface. The external storage device 12 is connected to the connector 14 by the external serial ATA (eSATA) interface. Numeral 42 designates an eSATA cable.

The video camera 10 can be connected to the external storage device according to eSATA, and therefore, the data can be transferred to the external storage device at the maximum rate of 150 MB/s higher than the maximum rate of 60 MB/s of USB2.0 now widely used. The hard disk drive reads the data at the rate of about 100 MB/s, and therefore, USB2.0 which may constitute the bottleneck against the data transfer can be obviated by employing the eSATA.

In the video camera configured as shown in FIG. 1, the video signal obtained in an imaging unit 34 having a lens unit and a CCD is converted into a digital signal by a video processing unit 36 and supplied to the system control unit 22. The encode/decode processing unit 26 of the system control unit 22 executes the process of coding the digital signal according to such a scheme as JPEG, MPEG2, MPEG4 or AVC/H.264.

The encode/decode processing unit 26 sends out the encoded video signal from the ATA controller 24 through the ATA bus 20 to the HDD 16, which in turn records the audio/video information in a magnetic disc.

In the case where the video camera 10 reproduces the information recorded in the HDD 16, for example, the encoded video information is read from the HDD 16, and decoded by the encode/decode processing unit 26. Based on the decoded video information, a display screen generating unit 42 generates a video signal constructing the display screen and displays it on a display unit 40.

An operating unit 38 outputs the input information obtained by the button operation of the user, for example, to the system control unit 22. Based on the input information, for example, the system control unit 22 executes the process of activating the apparatus and dubbing the information recorded in the HDD 16 to the external storage device 12. The system memory 26A of the system control unit 22 stores the activation process program and the dubbing process program.

Numeral 30 designates a SDIO bus based on SDIO for connecting the SD card to the encode/decode processing unit 26, and numeral 32 a SD card connector connected to the SDIO bus. The encoded information can be recorded also in the SD card by connecting the SD card to the SD card connector 32.

The ATA interface is configured of an ATA bus, a host connector and a device connector. The master or the slave for the device can be set by a method using the CSEL signal of ATA standard or a methods using a master/slave jumper pin of the device. Numeral 24 designates an internal memory configured of a RAM used for temporarily storing the various control programs and the large capacity data such as the audio/video information.

According to the ATA standard, when the system control unit 22 is activated, the master device 16 monitors the PDAIG signal on the ATA bus 20, confirms that the PDAIG signal is asserted (high to low) by the slave device, and sets the self-diagnosis result of the slave in a specified bit of a common register 24A of the ATA controller 24. The ATA controller 24, based on the confirmation that the self-diagnosis result of the slave is set in the specified bit, judges that the system control unit 22 is normally activated.

In view of the fact that the video camera 10 shown in FIG. 1 is normally activated without connecting the slave device 12 thereto, the PDAIG signal terminal of the ATA bus 20 is left high but not reduced to low by the slave device 12. Thus, the video camera cannot be activated as long as the master device 16 waits for the assertion of the PDAIG signal terminal, resulting in the inconvenience of an erroneous activation process.

Incidentally, the PDAIG signal is related to the status of the slave device and based on the ATA specification. The slave device thus asserts the PDAIG signal on the ATA bus 20 upon complete self-diagnosis. The master device detects the asserted PDAIG signal so that the slave device is connected to the ATA bus 20 while at the same time recognizing that the standby state is entered.

According to the first embodiment shown in FIG. 1, regardless of whether the external device is connected to the connector or not, the PDAIG signal is asserted by turning the PDAIG signal terminal on the ATA bus 20 to low from high level before the master device 16 issues the ATA command at the time of apparatus activation according to the activation process program of the system control unit 22.

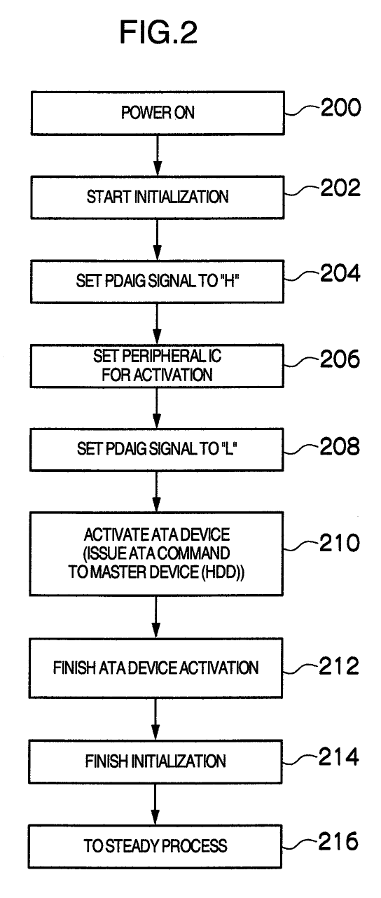

FIG. 2 is a flowchart showing the operation according to the activation process program of the system control unit 22 at the time of activating the video camera. First, the power supply is turned on (200). The activation program is started and the hardware and the various programs are initialized (202). Then, according to the activation program, the PDAIG signal assigned to a specified pin of the host connector is set high (H) (204).

Then, the set operation is performed to activate the peripheral hardware (206). From this time point, the peripheral hardware begins to be activated. In this process, the status register 24A of the ATA controller 24 is set by the connection between the master device and the slave device. Specifically, the master device 16 updates the specified bit of the status register 24A of the ATA controller 24 (for the master device) to “master device available”.

In the case where the slave device 12 is connected to the connector 14, the specified bit of the status register 24A (for the slave device) of the ATA controller 24 is updated to “slave device available”. In the case where the slave device is not connected to the connector 14, on the other hand, the specified bit is not updated. When the user attempts to record an image using the video camera, the slave device 12 is not normally connected to the connector 14, and therefore, the specified bit of the status register 24A (for the slave device) is left without being updated.

According to the activation program, upon the lapse of a predetermined time for the process of step 206, the PDAIG signal is set to low from high state (208) to create the asserted state of the PDAIG signal. The system control unit 22 causes the master device 16 to detect the asserted PDAIG signal and thus virtually recognize the situation in the same manner as if the slave device 12 exists on the ATA bus 20 even if it is not actually connected to the connector 14.

The master device 16 that has virtually recognized the slave device 12 sets the information indicating that the master device 16 is ready, in the specified bit of the register 24A of the ATA controller 24.

Once the ready state of the master device 16 set in the specified bit is recognized according to the activation program, the ATA command such as “Identify” or “Set features” is generated for the master device (ATA device) 16 and set in the register 24A. Thus, the ATA command is issued to the master device (210), and the ATA device activation process according to the activation program is finished (212). Next, according to the activation program, the initialization process is finished (214) followed by the transfer to the steady process after activation (216). The activation program normally completes the activation process in such a manner as an example shown in FIG. 2.

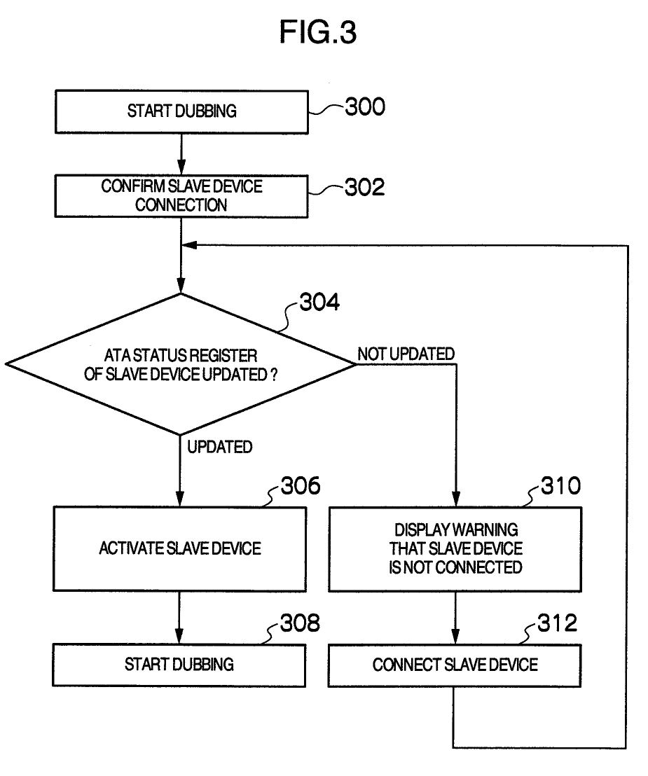

The operation of the system control unit at the time of dubbing from the master device 16 to the slave device 12 is explained. FIG. 3 is a flowchart showing the operation performed according to the dubbing process program.

According to the dubbing process program, the start of the dubbing operation is detected based on the user operation (300). Then, the status register 24A (for the slave device) of the ATA controller 24 is confirmed (302).

In the case where the slave device 12 is already connected to the connector 14, the information in the specified bit of the register for the slave device is already updated, while the slave register is left without being updated in the case where it is not connected to the connector.

According to the dubbing process program, whether the specified bit of the slave device register is updated or not is judged, and in the case where the specified bit is updated, the dubbing process is started after activating the slave device (306 to 308). In the case where specified bit is not updated, on the other hand, the warning that the slave device 12 is not connected to the connector 14 is displayed according to the dubbing process program (310).

Assume that the user who has received the warning thus displayed connects the slave device 12 to the connector 14 (312). Then, the slave device 12 updates the specified bit of the common register (slave register) to “slave device available”. According to the activation process program, upon judgment in step 304 that the slave device register is updated, the warning display is suspended and steps 306 and 308 are subsequently executed.

In the video camera shown in FIG. 1, the system can be activated normally by the software process without any special change in the master device or the slave device even in the case where the external slave device is not connected to the connector.

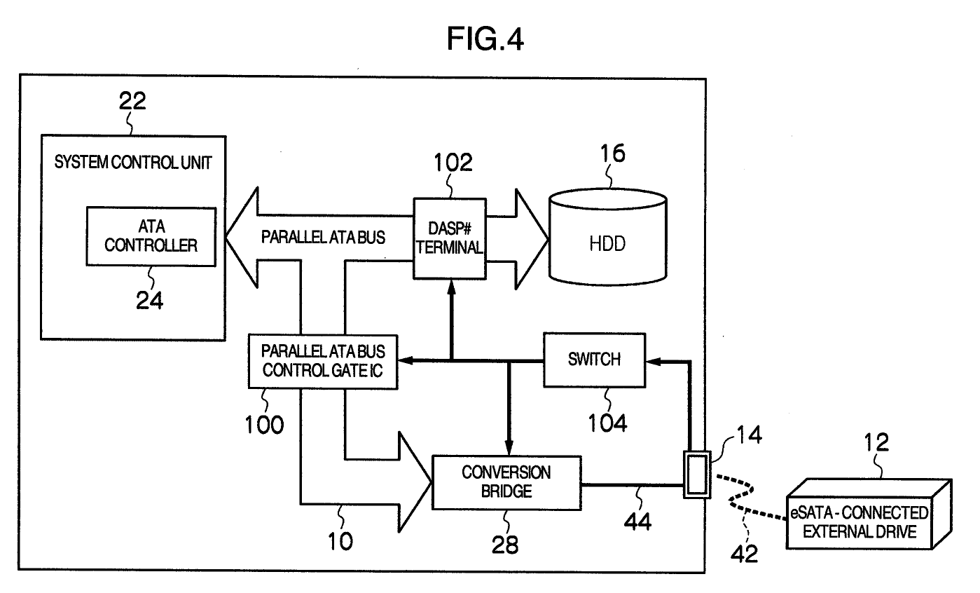

Next, another embodiment of the invention is explained with reference to FIG. 4. In the embodiment described above, the video camera with the external storage device not connected to the connector can be normally activated by the PDAIG signal assertion according to the activation program.

According the embodiment described below, in contrast, a special hardware configuration is used for the information recording apparatus. Thus, as long as the slave device 12 is not connected to the connector 14, the HDD 16 is operated only as a master device, and only after the slave device 12 is connected to the connector 14, the HDD 16 is operated with as a master device connected with the slave device.

The eSATA connector 14 includes a switch 104 for detecting the connection of an eSATA-connected external drive 12. Once the eSATA-connected external drive 12 is connected to the eSATA connector 14, the switched is turned on.

In the case where the eSATA-connected external drive 12 is not connected to the eSATA connector 14, on the other hand, the eSATA connector 14 sets the DASP signal terminal 102 of the ATA bis 10 at low level, and the HDD 16, detecting that the DASP signal is low, recognizes that the slave device 12 is not existing on the ATA bus 10.

Further, the switch 104 of the eSATA connector 14 disconnects the ATA bus 10 by the gate IC 100, while at the same time switching off the power supply of the conversion bridge 28. As a result, the CSEL signal is connected to GND on the host controller 24. Thus, the HDD 16 operates only as a master controller.

Once the eSATA-connected external device 12 is connected to the eSATA connector 14, on the other hand, the switch 104 of the eSATA connector 14 is turned on, and the DASP signal terminal 102 of the ATA bus 10 is set at high level.

The HDD 16 that has detected the assertion of the DASP signal recognizes the existence of the slave device 12 on the ATA bus 10. The eSATA connector 14, by turning on the gate IC 100 and the conversion bridge 28, opens the CESL signal. As a result, the HDD 16 comes to know that it operates as a master device with the slave device connected.

In the case where the video camera is activated with the eSATA-connected external device 12 not connected to the connector 14, therefore, the HDD 16 receives the notification from the control unit (connector 14) of the video camera in the form of the ATA signal (DASP) indicating the status that the slave device is not connected to the connector 14, and the HDD recognizes that it operates only as a master device with the slave device 12 not connected. As a result, the system control unit 22 can normally complete the activation process without waiting for the notification (PDAIG signal) from the slave device.

Once the slave device 12 is connected to the connector 14, the HDD operates as a master device connected with a slave device, and therefore, the HDD data can be transferred to an external storage device.

The embodiments described above represent a video camera as the information recording apparatus. Nevertheless, the invention is equally applicable to any of various information recording apparatuses such as the personal computer, electronic camera, car navigator or the mobile phone having a built-in HDD and an external optical disk drive connected thereto.

1. An information recording apparatus comprising:
a host controller;
a first storage device;
an ATA interface for connecting the first storage device to the host controller as a master device;
a connector for connecting a second storage device as a slave device to the ATA interface; and
a control unit for outputting the ATA signal related to the status of the second storage device to the ATA interface at the time of activating the apparatus.

2. The information recording apparatus according to claim 1,
wherein the ATA signal is output to the first storage device connected to the ATA interface with the second storage device not connected to the connector.

3. The information recording apparatus according to claim 2,
wherein the control unit asserts the PDAIG signal as the ATA signal at the time of apparatus activation, and the first storage device judges that the second storage device is ready by detecting the asserted PDAIG signal.

4. The information recording apparatus according to claim 1,
wherein the ATA interface is governed by the parallel ATA specification,
the apparatus further comprising a conversion bridge for converting the parallel ATA signal into the serial ATA signal,
wherein the conversion bridge is connected to the connector by the serial ATA interface and the second storage device is connected to the connector by the serial ATA interface.

5. The information recording apparatus according to claim 4,
wherein the second storage device is connected to the connector by an external serial ATA interface.

6. An information recording apparatus comprising:
a host controller;
a first storage device;
a parallel ATA bus for connecting the first storage device to the host controller as a master device;
a conversion bridge connected to the parallel ATA bus for converting the parallel ATA signal to the serial ATA signal; and
an external connector connected to the conversion bridge through a serial ATA bus with the second storage device connected through an external serial ATA bus;
wherein the host controller asserts and outputs the PDAIG signal of the ATA specification to the parallel ATA bus at the time of apparatus activation, and
wherein the first storage device, by detecting the asserted PDAIG signal, judges that the second storage device not connected to the connector is ready.

7. The information recording apparatus according to claim 6,
wherein the first storage device is a hard disk drive and the second storage device is an optical disk drive.

8. An information recording apparatus for recording information, comprising:
a first recording means built in the information recording apparatus;
a connecting means for connecting a replaceable second recording means to the information recording apparatus;
a bus control means for controlling the bus for connecting the first recording means and the connecting means; and
a control means for controlling the activation of the information recording apparatus;
wherein the first recording means receives the control signal output from the second recording means in the case where the second recording means is connected to the connecting means at the time of apparatus activation;
wherein the control means transmits the control signal to the first recording means in the case where the second recording means is not connected to the connecting means at the time of apparatus activation;
wherein the first recording means, upon receipt of the control signal, outputs a predetermined signal related to the standby state to the bus control unit; and
wherein the control means completes the activation by detecting that the bus control means has received the predetermined signal related to the standby state from the first recording means.
